(19) United States
(12) Patent Application Publication
(10) Pub. No.: US 2018/0132493 A1
(43) Pub. Date: May 17, 2018

(54) NON-PROOFED NON-FERMENTED YEAST RISING DOUGH AND METHOD FOR MAKING THE SAME

(71) Applicant: SFC Global Supply Chain, Inc., Marshall, MN (US)

(72) Inventors: Rongxuan Cai, Marshall, MN (US); Pat Suprenant, Marshall, MN (US); Amber Kirckof, Marshall, MN (US)

(21) Appl. No.: 15/812,309

(22) Filed: Nov. 14, 2017

Related U.S. Application Data
(60) Provisional application No. 62/422,310, filed on Nov. 15, 2016.

(51) Int. Cl. A21D 10/00; A21D 6/00; A21D 8/06; A21D 8/02; A21D 2/18

(52) U.S. Cl. CPC A21D 10/002; A21D 6/008; A21D 2/18; A21D 8/02; A21D 8/06

(57) ABSTRACT

A bakery product is produced by mixing ingredients to produce a dough composition, the ingredients including water, flour, and thermostable yeast; making up a raw bakery product having a first volume from the dough composition; leavening, freezing, and baking the frozen raw bakery product to produce a finished bakery product. Leavening includes resting and not proofing or fermentation. After leavening and immediately prior to baking the raw bakery product has a second volume that is less than 150% of the first volume. The finished bakery product has a third volume that is at least 200% of the first volume. A packaged ready-to-bake frozen dough product includes a frozen dough product having a dough matrix; thermally stable yeast; and a plurality of air cells, at least 90% of the air cells being smaller than 4 mm, and a packaging including instructions to bake the dough without proofing or fermenting the dough.

### CROSS-REFERENCE TO RELATED APPLICATION

This application claims the benefit of U.S. Provisional Application No. 62/422,310, filed Nov. 15, 2016, which is hereby incorporated by reference in its entirety.

### FIELD

The present disclosure relates to frozen dough products and methods for making the same. In particular, the present disclosure relates to non-proofed, non-fermented freezer-to-oven dough products that are leavened by yeast and that have a fresher appearance after baking than their proofed counterpart.

### BACKGROUND

Modern bakers, including professional bakers and home bakers alike, often desire to prepare baked goods by methods that are faster and more convenient than traditional methods. Traditional methods typically rely on time-consuming fermentation and proofing steps to provide leavening and flavor to baked goods. In order to forgo or shorten such steps, chemical leaveners have become a widely used alternative or additive to yeast, making the production of leavened bakery products faster and cheaper. Chemical leaveners or a combination of chemical leaveners and yeast are usually necessary to produce a non-proofed dough. However, while simplification of bakery manufacturing is desirable, high quality bread dough cannot conventionally be achieved without proofing.

When chemical leaveners alone are used to leaven dough without yeast, a very different texture than yeast bread usually results. Typically, the texture of bakery goods made with chemical leaveners is denser and cracker- or biscuit-like. Non-proof chemical leavening methods are therefore typically more suitable for pastry production in the manufacture of biscuits, cookies, crackers, cakes, etc. due to the short texture requirement of pastry products. A short bite and crunchy texture usually are the result of using chemical leaveners such as sodium bicarbonate or a combination of sodium bicarbonate and one or more leavener acids, such as sodium pyrophosphate, mono calcium phosphate or sodium aluminum phosphate.

Increasing awareness and interest in healthy eating among consumers has manufacturers returning back to yeast-leavened goods, seeking to avoid the use of chemical leaveners that may be considered unfamiliar and undesirable by consumers. A clean label with natural ingredients has become an important food trend for product development. However, due to the fact that yeast is a live organism, leavening bakery goods with yeast only and without using a proofing step presents challenges when consumers and producers alike desire fresh products that can be prepared fast.

One option for making the preparation of baked goods faster is to provide a frozen dough. One disadvantage with the proofed frozen dough is that the dough is typically more susceptible to physical damage and chemical changes, rendering the dough less fresh at the end use. In a typical yeast-leavened baking process, a final fermentation step (i.e., proofing) occurs just prior to baking. Proofed dough has lost its yeast vitality and is fragile during frozen storage and transportation in the sense that the dough has limited gas-holding ability. A frozen dough will typically lose its fresh bakery appearance compared to its non-frozen counterpart. This loss of quality is accelerated when the dough is proofed before freezing.

In the past, problems with frozen dough have been overcome by producing the raw dough without proofing and with substantially higher amounts of yeast than in a typical bakery process. At least some of the yeast would survive the frozen storage, and can be activated when the dough is thawed and proofed before baking. Proofing the dough after frozen storage and immediately prior to baking avoids gas losses and better retains yeast activity throughout frozen storage, resulting in a desired volume, texture, flavor, and freshness of the final bakery product. However, thawing and proofing of the dough prior to baking is very time consuming, and achieving proper proofing conditions may be difficult for the consumer or user of the dough.

There is a desire to have frozen dough available for baking at homes, commercial facilities, and public institutions. There is further a desire to be able to enjoy fresher, high-quality, yeast-leavened bakery products from frozen storage without the need to wait for several hours as the dough thaws and proofs. Users often find long wait times inconvenient if the dough is not readily available for baking at all times. It is against this background that the present disclosure is made.

### SUMMARY

The present disclosure relates to bakery products and methods for making bakery products. In particular, the present disclosure relates to bakery products made with thermally stable yeast and without a proofing step or a fermentation step, where the bakery products can be frozen before baking. The baked product has a fresher appearance than proofed dough product made with regular yeast.

The bakery product is produced by mixing ingredients to produce a dough composition, where the ingredients include water, flour, and thermally stable yeast; making up a raw bakery product from the dough composition, the made up raw bakery product having a first volume; leavening the raw bakery product; freezing the leavened raw bakery product; and baking the frozen raw bakery product to produce a finished bakery product. The leavening step includes resting and does not include proofing or fermentation. After leavening and immediately prior to baking the raw bakery product has a second volume that is up to 150% of the first volume, and wherein the finished bakery product has a third volume that is at least 200% of the first volume.

A non-proofed non-fermented frozen dough comprises a dough matrix comprising flour, water and one or more dough conditioners comprising a polysaccharide selected from propylene glycol alginate, sodium alginate, xanthan, gellan, pectin, guar gum, carrageenan, locust bean gum, gum Arabic, carboxymethyl cellulose, METHOCEL, BENECEL or a combination thereof; thermally stable yeast; and a plurality of air cells, wherein the dough has a temperature below 32° F., and wherein at least 90% of the air cells in the dough are smaller than 4 mm in diameter.

A packaged ready-to-bake frozen dough product includes a frozen dough product having a dough matrix; thermally stable yeast; and a plurality of air cells, at least 90% of the air cells being smaller than 4 mm in diameter, and a packaging including instructions to bake the dough without proofing or fermenting the dough.

### BRIEF DESCRIPTION OF DRAWINGS

FIG. 1 is a flow chart of a typical process for preparing yeast-leavened bread.

FIG. 2 is a flow chart of a method for preparing yeast-leavened bakery products according to an embodiment.

FIG. 3 is a schematic depiction of a Risograph.

FIG. 4 is a schematic depiction of a packaged product according to an embodiment.

FIG. 5 is a DSC scan of samples in Example 1.

FIGS. 6A and 6B are graphical presentations of results of Example 2.

FIG. 7 is graphical presentation of the results of Example 3.

FIGS. 8A and 8B show results of Example 8.

FIG. 9A-D show results of Example 9.

FIG. 10A-D show results of Example 10.

### DETAILED DESCRIPTION

The present disclosure relates to frozen dough products and methods for making the same. The present disclosure further relates to frozen dough products comprising a thermostable yeast and a dough rheology suitable for gas holding and rising. The present disclosure further relates methods of making the frozen dough without using a proofing step or fermentation step. In particular, the present disclosure relates to non-proofed, non-fermented freezer-to-oven dough products that are leavened by yeast.

The term “fermentation” is used here to describe a rising of the dough due to yeast activity, where yeast consumes sugars in the dough and produces carbon dioxide gas. “Fermentation” can be used to describe a first, second, or subsequent fermentation step in the preparation of yeast-leavened baked goods.

The terms “fermenting” and “fermented dough” are used here to refer to yeast dough undergoing or having undergone at least some fermentation, such as a first rise, second rise, or proofing, to leaven the dough. The optimum temperature for yeast fermentation is typically about 75 to about 85° F. (about 24 to 29.5° C.) and a humidity of about 75 to about 80%, depending on dough type. If conducted, fermentation usually takes several hours, e.g., 2 to 4 hours for a sponge-dough process during bread making.

The terms “non-fermented” and “non-fermented dough” are used here to refer to yeast dough products that are not fermented either before or after frozen storage and prior to baking.

The term “proofing” is used here to describe a final fermentation step before baking in the preparation of yeast-leavened baked goods. Unless otherwise specified, the term “proofing” as used here refers to a full proofing step, where substantially all of the available vital yeast in the dough is used up during fermentation and becomes spent yeast, and where the dough is leavened to a state that is ready for baking. Proofing is typically performed at an elevated temperature and humidity, e.g., about 75 to about 115° F. (about 24 to about 46° C.) or about 90 to about 110° F. (about 32 to about 43° C.), and relative humidity of about 60 to about 90%. Proofing can be done in a proofer, such as a temperature and humidity controlled room or cabin.

The terms “non-proofed” and “non-proofing” are used here to refer to yeast dough products that are not proofed either before or after frozen storage and a proofing step is eliminated during the preparation of the dough. Leavening action of the yeast is accomplished by unconventional mechanisms beyond proofing, e.g., by a short rest of dough and by yeast activity in oven during baking at temperatures different than those of the proofing conditions.

The term “non-proofed, non-fermented dough” is used here to refer yeast dough products that are not proofed or fermented as described above.

The terms “resting” and “rested dough” are used to refer to allowing the dough to rest for a period of time (e.g., from a few minutes up to an hour) but without allowing any significant fermentation to occur. For example, resting can refer to a rest period of less than about 1 hour, or less than about 30 minutes. During resting, some gas cell nucleation in the dough may occur. However, the rest period is not long enough for the gas cells to grow in size to any significant degree (e.g., as would happen during fermentation or proofing). Resting is typically performed at ambient temperature, e.g., at about 68 to about 80° F. A “rested dough” does not refer to a fermented or proofed dough.

The term “gas nucleation sites” is used here to describe initial spots of carbon dioxide formation in dough creating gas or air cells.

When gas nucleation occurs during resting, the cells have not grown to any significant degree. Typically, when the gas nucleation sites initially form, the number of cells is large but size of the cells is small. With time and changes in environmental conditions (e.g., changes in temperature, humidity during fermentation), cells will grow and merge to larger sizes.

The term “gassing plateau” is used here to describe a slow gassing rate of yeast after a transition from a very high gassing rate. The gassing plateau can be seen in a Risograph as a gassing rate curve as a function of time.

Prior to reaching the gassing plateau, the rate of yeast gassing is typically increasing and new nucleation sites are generated. Reaching the gassing plateau suggests that a maximal number of nucleation sites has been created, but significant fermentation has not yet occurred. The beginning of the gassing plateau corresponds to the beginning of steady gassing, where the gas cells will begin to fill with fermentation gases, growing in size, and merging with each other.

The terms “yeast-leavened dough” and “yeast-leavened bakery products” are used here to describe dough and bakery products that include yeast for producing gas cells in the dough for leavening. Yeast-leavened dough and yeast-leavened bakery products may optionally include an additional leavener, such as a chemical leavener, to impart additional leavening to the product.

While yeast-leavened dough and yeast leavened bakery products have a broader definition implying all types of yeast products proofed or non-proofed alike, fermented or non-fermented alike, the term yeast leavened dough or yeast-leavened bakery products of this disclosure refer to dough or bakery products that are yeast-leavened but without a proofing or fermentation step. Leavening action of the yeast is accomplished by mechanisms other than ordinary proofing or fermentation, such as resting until full nucleation forms and leavening action in the oven during baking.

Yeast-leavened dough, as described here, comprises a dough base. The dough base may be any typical dough base used for yeast-leavened bakery products. Typical dough bases include flour, water, salt, and optionally fats, leaveners, flavorants, preservatives, dough conditioners or enhancers, or combinations thereof.

The term “thermostable yeast” is used here to refer to yeast (e.g., specifically selected yeast strains) that is capable of withstanding a broader temperature range (e.g., lower and higher temperatures) than ordinary, non-thermostable yeast. Thermostable yeast may have a higher survival rate at freezing temperatures (e.g., at −20° F. or −29° C.), and may be able to survive temperatures of up to 163° F. (73° C.), whereas ordinary yeast will typically only be able to withstand temperatures of up to 140° F. (60° C.) and has a lower survival rate at freezing temperatures. Thermostable yeast may also be referred to as thermotolerant yeast or thermally stable yeast.

Applicants have surprisingly discovered that some commercially available yeast strains that are specifically developed and marketed for increased survival at low (e.g., freezing) temperatures, also have an improved tolerance for high temperatures. Such yeast strains may be utilized as thermostable yeast in the compositions of the present disclosure. Yeast strains suitable for use as thermostable yeast are commercially available, e.g., from PAK Group North America in Pasadena, Calif., and Red Star Yeast Company, LLC, Milwaukee, Wis.

The term “yeast viability” is used here refer to the percentage of viable yeast cells in a population. When yeast are viable, they are alive and are either active or capable of being activated to ferment sugars.

The term “about” is used here in conjunction with numeric values to include normal variations in measurements as expected by persons skilled in the art, and is understood to have the same meaning as “approximately” and to cover a typical margin of error, such as ±10% of the stated value.

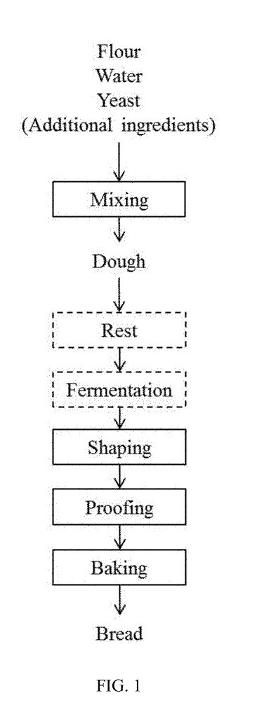

A schematic flow diagram of a typical prior art yeast-leavened bakery good preparation process is shown in FIG. 1. Dry ingredients (e.g., flour, salt, and other optional ingredients) are mixed in a mixer. Water or other liquid and yeast (e.g., cream yeast) are added and the resulting mixture is mixed (e.g., kneaded) for several minutes. For example, the dough can be mixed for a period of time, e.g., about 1 minute, at low speed (about 45 rpm) and for another period of time, e.g., about 5-9 minutes, at high speed (about 80 rpm). The temperature of the dough can be controlled, for example, by adding the liquid at a higher or lower temperature than room temperature. A commercially produced dough is typically mixed in a large stand mixer, such as those available from Hobart Corp. in Troy, Ohio.

During the preparation process, the dough may be allowed one or more rest periods. Commonly, the mixed dough is allowed to rest for a period of time, e.g., about 5 to 20 minutes, prior to further processing. After resting, the dough can be allowed to rise in one or more fermentation steps. The dough may be deflated before and/or after each fermentation step. During fermentation, the yeast consumes sugars in the dough and produces carbon dioxide gas, which causes the dough to rise and the volume of the dough to increase. Typically, substantially all of the yeast is spent by the end of the final fermentation step (i.e., proofing).

In the prior art process, the fermentation steps can be controlled by controlling the temperature of the dough and by controlling the temperature and humidity of the environment. For example, the dough may be prepared with warm liquid (e.g., warm water) such that the temperature of the dough is about 75 to about 98° F. (about 24 to about 36.6° C.). The dough may then be maintained at a temperature of about 75 to about 90° F. (about 24 to about 32° C.) and relative humidity of about 60 to 90% during the fermentation step. The duration of the fermentation step depends on the type of dough (e.g., dough moisture content, or type of bakery product), the type of yeast used, the amount of yeast, yeast vitality and activity, the temperature, and the extent to which fermentation is allowed to progress. Higher temperatures generally result in faster fermentation. However, different fermentation speeds usually result in different flavor profiles, and it may be desirable to use a slower fermentation process to produce a specific, desired flavor profile. Slower fermentation can be achieved, for example, by using a lower temperature, e.g., about 60 to about 70° F. (about 15.5 to about 21° C.) or even lower.

In what is known as a “sponge dough” process, a sponge is first prepared and fermented prior to mixing in further ingredients to prepare the dough. To differentiate from the sponge dough process, the process that does not involve using a sponge is sometimes referred to as the “straight dough” process. The sponge is generally a loose, high-moisture starter that typically includes flour, water and yeast. The sponge can be fermented at a relatively low temperature for several hours. After fermentation of the sponge, final dough ingredients are added to prepare the dough, which typically include at least water, flour, and salt and optionally other flavoring ingredients. The dough may be kneaded, and may further undergo one or more rest and fermentation steps.

Another alternative prior art dough preparation process, sometimes referred to as the “no time dough,” involves only mixing the dough base and proceeding directly to shaping the dough without intermediate fermentation steps but including a proofing step.

Further referring to the process of FIG. 1, the dough is shaped into a desired shape, such as a bread loaf, sandwich bread (e.g., a loaf baked in a pan), boule, baguette, Italian bread, French bread, rolls, buns, bread sticks, pup loaves, pizza crust, flat bread, etc. The shaping of the dough can be referred to as the “make-up.” The shaped dough is then proofed. Proofing can be done at an elevated temperature and humidity, such as a temperature of about 80 to about 110° F. (about 26.5 to about 43° C.) and 60 to 90% relative humidity. In commercial operations, proofing is often done in a proofer or proofing chamber that maintains the desired environmental conditions during the proofing step. An example of a commercially available proofer is the REVENT Proofer available from Revent Inc. in Piscataway, N.J. The proofing step may last anywhere from 30 minutes to several hours, depending on the conditions and on how much yeast activity remains in the dough. A dough that has been minimally fermented (or not fermented at all) prior to the proofing step may require a longer proofing time.

The yeast most commonly used in commercial bakery operations is cream yeast. Cream yeast consists of suspended yeast cells in liquid. Other commonly available forms of yeast include compressed yeast, which is fresh yeast compressed into a block and can be used as a compressed crumbled yeast, compressed cake yeast, semi-dry yeast, frozen yeast, and dry yeast, which is available as active dry yeast or instant yeast. While fresh yeast such as cream yeast or compressed yeast is typically the yeast of choice for modern bakeries with high throughput, active dry yeast and instant yeast are conveniently stored at ambient temperatures, have a longer shelf-life, and are more user-friendly. Frozen yeasts are typically used for frozen dough production where the dough is proofed after frozen storage and prior to baking. Dough made of frozen yeast has a longer frozen shelf-life. Proofing time for the frozen dough varies but is typically several hours long not including the slacking of the dough before proofing.

If the dough is intended to be baked without proofing, a chemical leavener system is typically required. Examples of non-proofed dough can be found in Brodie, et al., US Patent Application 2009/0123607A1; Reuter et al., US Patent Application US2004/0208970A1; Kulkarni et al., US Patent Application 2003/0049359; Behatia et al., US Patent application 2007/0218167; Goedeken et al., US Patent Application US20050129821A1; and Preyn et al., U.S. Pat. No. 5,451,417. All the above patents and applications use chemical leaveners, with the option of additional yeast to impact the flavor and assist in rising typically using a proofing step or a fermentation step.

Examples of fermented yeast dough can be found in Domingues et al., U.S. Pat. No. 7,341,753; Domingues et al., U.S. Pat. No. 6,884,443; and Lonergan, U.S. Pat. No. 7,175,865.

Home bakers, restaurants, and other food service facilities alike have a desire to be able to bake yeast-leavened bakery goods, such as bread and pizza, from pre-prepared dough that does not require long thawing and/or proofing times. Conveniently, such bakery goods can be baked from frozen dough. However, typically a frozen yeast dough will require thawing and proofing prior to baking—a process that may take several hours—to produce satisfactory results, or will include chemical leaveners. If typical yeast dough is proofed prior to freezing, the freezing and possible freeze-thaw cycles during frozen storage and transportation may result in poor rising and inferior quality of the final product. The yeast will cease to produce gases under freezing temperatures, and the dough will undergo physical changes that can result in the rupture of cells and loss of gases already generated by the yeast.

The present disclosure provides a composition and method that allows baking a frozen non-proofed dough without further wait times, such a thawing or proofing step. The present disclosure also provides a composition and method for preparing a non-proofed frozen dough that rises during baking without a proofing or fermentation step. The bakery products produced using the composition and/or method of the present disclosure exhibit improved fresh appearance, a smooth surface, and an appearance of a bakery good prepared from a proofed fresh dough without needing proofing, including large, uneven air cells in the finished baked good.

Yeast vitality affects frozen dough and the performance of the frozen dough through baking. Whether the dough is fermented before freezing or not, the existence of vital yeast capable of surviving freezing conditions is directly correlated with product quality. Harsh freezing conditions, and freeze-thaw cycles in particular, have a negative impact on yeast vitality and subsequent yeast activity. Frozen storage damages yeast cells by causing physical damage to the cells. For example, water around yeast cells will form ice that damages the yeast cells. Yeast in a non-fermented, non-proofed dough has been found to lose 20-40% of its activity after one week of frozen storage at −20° F. (−29° C.). On the other hand, yeast in a proofed dough has been found to lose about 80% of its activity after one week of frozen storage at −20° F. (−29° C.).

Full proofing, while resulting in desired volume, flavor, and texture characteristics, uses up active yeast, and little yeast activity is expected to remain after proofing, whether before or after freezing. Sometimes dough is proofed prior to freezing in an effort to save time at the back end to allow baking of the dough without another proofing step. However, proofed dough retains diminished gas-holding capacity and may collapse as a result. Since the proofing step has used up substantially all vital yeast, no yeast activity remains to replace any lost volume either before or during baking.

Par-proofing is known as a proofing step that provides less than full proofing. However, full flavor and volume development is not achieved by par-proofing. Another drawback of par-proofing is that it makes the yeast more vulnerable and renders the metabolized yeast unable to survive harsh freezing conditions, causing a higher fatality rate of yeast. This in turn results in loss of yeast activity and gassing power in the final proofing step and/or final leavening action during baking.

When dough is frozen without first proofing the dough, yeast activity is preserved better than in processes with proofing steps prior to freezing. Yeast that remains active after frozen storage can then be used in the proofing step prior to baking. However, proofing before baking requires bringing the dough up to a suitable proofing temperature (about 90 to about 110° F. (−29° C.)), and waiting for the proofing step to complete. This may take several hours.

Yeast strains vary slightly in their preference for environmental parameters, such as temperature, moisture, and sugar concentrations. Saccharomyces cerevisiae, the most commonly used baking yeast, prefers a fermentation temperature of about 80-95° F. When this yeast is not actively fermenting, it can tolerate temperatures ranging from deep frozen up to its thermal death (denaturation) point, about 130 to about 140° F. (about 55 to about 60° C.). Freezing temperatures, particularly in the presence of free water, can damage yeast and impact yeast vitality.

The dough compositions of the present disclosure include thermostable yeast, which typically is able to survive temperatures of up to 163° F. (73° C.). The dough composition is not fermented or proofed prior to freezing and can be frozen as a raw, non-proofed dough. After freezing, the dough is simply baked without the need for a thawing or proofing step, for example by a deli, a restaurant, a cafeteria, an institutional kitchen, a store, or by a consumer. The Applicants have surprisingly discovered that coupling thermostable yeast with the particular dough composition and rheology described herein yields a dough that can be frozen without proofing or fermentation and baked from its frozen state without requiring thawing or proofing, and will result in a baked good that has the appearance of a baked good prepared from proofed, fresh dough. It is hypothesized that because the product can be produced without a fermentation or proofing step, more sugars remain in the dough, yielding a browner crust upon baking. Further, as compared to fermented/proofed dough products, where the air cells at the surface of the crust often collapse during baking, the air cells at the surface of the present dough composition continue to expand during baking due to higher yeast activity, resulting in a fuller, smoother and more appealing surface and a fresher appearance.

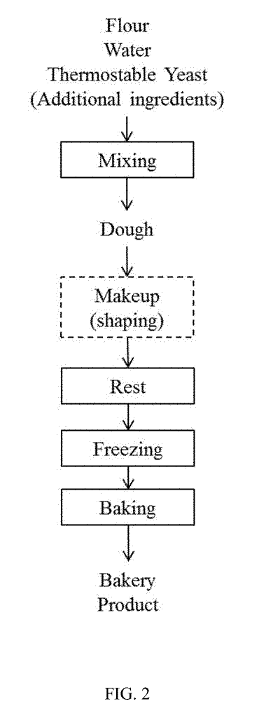

A simplified schematic of the method for preparing the bakery product according to an embodiment is shown in FIG. 2. The bakery product is produced by mixing flour, water, thermostable yeast, and optionally additional ingredients to form a dough. The dough can be made up (e.g., sheeted, shaped, and/or cut) into a desired shape (e.g., a loaf or a crust). The dough is then allowed to rest for a short period of time, after which the dough is frozen. The frozen dough can be baked directly from the frozen state without proofing. This allows for the dough to be delivered to consumers or retail locations in its frozen state with instructions to bake the product without thawing, fermenting, or proofing.

According to embodiments of the present disclosure, the dough composition is prepared with a dough base comprising thermostable yeast. The dough base has a suitable rheology that allows for stretching of the dough to increase in volume due to yeast leavening action, and provides sufficient gas holding ability after gas nucleus sites in the dough have been generated.

The dough base is made up of an aqueous liquid, such as water, flour, and optionally some additional components. The dough base may comprise, for example, at least about 10, 15, 20, 25, or 30% aqueous liquid by weight. The dough base may comprise less than about 60, 55, 50, 45, 40, or 35% aqueous liquid by weight. According to some embodiments, the dough base comprises about 10 to about 60% water by weight, about 15 to about 55% water by weight, about 20 to about 50% water by weight, about 25 to about 45% water by weight, about 30 to about 40% water by weight, or about 30 to about 35% water by weight. In one embodiment, the dough base comprises about 32%, about 33%, or about 34% water by weight. The aqueous liquid may also comprise another liquid, such as milk or other dairy-based liquids (e.g., whey), broth, or a vegetable or legume based liquid, such as juice, soy milk, almond milk, etc. These amounts are understood to refer to added liquid. Some amount of moisture is also added in the form of the flour, as the moisture content of flour (e.g., wheat flour) may average about 10 to about 15% moisture by weight.

According to an embodiment, the dough base comprises flour, such as grain flour (e.g., wheat, oat, barley, rye, rice, corn, quinoa, millet, sorghum, triticale, amaranth, buckwheat sesame, flax, hemp, poppy, chia, and the like). Examples of flours include but are not limited to wheat flour (e.g., hard red, soft red, hard white, soft white, durum, etc.), barley flour, buckwheat flour, corn flour, corn meal, spelt flour, soy flour, millet flour, flaxseed flour, potato flour, potato starch flour, quinoa flour, rice flour, rye flour, sorghum flour, tapioca flour, and combinations thereof. In preferred embodiments, the flour includes wheat flour. In some preferred embodiments, the flour comprises 50% or more of wheat flour. In some embodiments, at least a portion of the flour is whole grain flour. The total amount of flour in the dough base depends on the desired moisture level of the dough and the intended food product. The dough base may comprise, for example, at least about 25, 30, 34, 36, 38 or 40% flour by weight. The dough base may comprise less than about 70, 65, 60, 55, 50, 45, or 40% flour by weight. According to some embodiments, the dough base comprises about 40 to about 70% flour by weight, about 45 to about 65% flour by weight, about 50 to about 65% flour by weight, or about 55 to about 65% flour by weight.

According to some embodiments, the dough base comprises fats, such as oils, hard fats, and mixtures thereof. Examples of oils include but are not limited to canola oil, rapeseed oil, sunflower seed oil, peanut oil, coconut oil, soybean oil, palm oil, olive oil, and the like. Examples of hard fats include but are not limited to butter, vegetable shortening, lard, palm oil, and the like. Fats used herein refer to added fats, excluding fats that may be found in, e.g., flour. The dough base may comprise, for example, at least about 0.1, 1, 2, 3, 4, 5, 6, 7, 8, 10, or 12% fat by weight. The dough base may comprise less than about 16, 14, 12, 10, 8, 6, 4, or 2% fat by weight. For example, the dough base may comprise about 0.1 to about 16% fat by weight, about 1 to about 14% fat by weight, or about 2 to about 12% fat by weight.

According to embodiments, the dough base may comprise salt and other flavoring ingredients. Examples of salt include but are not limited to sodium salts, potassium salts, magnesium salts, manganese salts, and mixtures thereof. Commercially available salts include but are not limited to table salt, iodized table salt, kosher table salt, sea salt, fleur de sel, smoked salt, and finishing salt. The dough base may comprise, for example, at least about 0.1, 0.5, 0.75, 1.0, 1.25, 1.5, 1.75, or 2.0% salt by weight. The dough base may comprise less than about 3.5, 3.0, 2.5, 2.0, 1.75, 1.5, 1.25, or 1.0% salt by weight. For example, the dough base may comprise about 0.1 to about 3.5% salt by weight, about 0.5 to about 3.0% salt by weight, about 0.5 to about 2.5% salt by weight, about 0.5 to about 1.75% salt by weight, about 0.5 to about 1.5% salt by weight, about 0.75 to about 2.5% salt by weight, about 1.0 to about 3.0% salt by weight, about 1.25 to about 3.0% salt by weight, about 1.5 to about 3.0% salt by weight, about 1.75 to about 3.0% salt by weight, or about 2.0 to about 3.5% salt by weight. Other flavoring ingredients may include seasonings such as herbs, spices, tomato, garlic, pepper, honey, mustard, barbeque, ranch, onion, bacon, cheddar cheese, parmesan, and the like. The dough base may comprise, for example, from 0 to about 8% or from about 1 to about 4% other flavoring ingredients by weight.

The dough base may also comprise one or more sweeteners. Suitable sweeteners include, for example, sugar, honey, agave nectar, maple syrup, corn syrup, high fructose corn syrup, buckwheat honey, and the like. Examples of sugar include but are not limited to cane sugar, brown sugar, granulates, powdered sugar, raw sugar, fructose, dextrose, and combinations thereof. Artificial sweeteners or sweeteners derived from natural sources (e.g., stevia leaf extract and certain sugar alcohols, such as sorbitol, xylitol, and mannitol) can also be used. The dough base may also include an acidifier, such as vinegar, cider vinegar, or food grade mineral acids.

The dough base may further comprise inclusions, such as pieces of fruit (e.g., dried fruit, such as apples, pears, apricots, peaches, plums, strawberries, blueberries, cranberries, etc.), nuts (e.g., pecans, walnuts, peanuts, cashews, macadamia nuts, brazil nuts, hazelnuts, almonds, etc.), vegetables (e.g., dried vegetables, such as potatoes, carrots, corn, beets, peppers, etc.), pieces of meat or meat bits, bacon bits, pepperoni bits, or cheese. For example, the dough base may include about 1 to about 10% inclusions.

According to embodiments, the primary leavener in the dough composition is yeast. In at least some embodiments, the dough composition is free of chemical leaveners. The yeast can be added to the dough in a suitable leavening amount, depending on the desired end product. For example, the dough base for a pizza dough may include a total amount of up to about 8% yeast by weight, or about 1 to about 6% yeast by weight. The dough base for a bread dough may include up to about 6% yeast by weight, or about 1 to about 4% yeast by weight.

In one embodiment, the dough only includes thermostable yeast and no other leaveners (e.g., no other yeast other than as an impurity of the thermostable yeast, and no chemical leaveners). In some embodiments, the dough includes both thermostable yeast and another type of yeast. The total amount of yeast in the dough base may be about 2-12 wt-%, about 3-9 wt-%, or about 4-6 wt-% based on the weight of the dough base. In some embodiments, the bakery product is free or substantially free of a chemical leavener. In some other embodiments, the bakery product contains chemical leaveners. Chemical leaveners include, for example baking soda (sodium bicarbonate) and baking powder. In some embodiments, the bakery product includes less than 5%, less than 1% or less than 0.5% of a chemical leavener. In some embodiments, the bakery product is substantially free of chemical leaveners.

The dough is provided in its made-up shape and form without fermentation or proofing prior to freezing. However, according to some embodiments, some rising may occur when the temperature of the dough rises above freezing, such as during freeze-thaw cycles during storage or transportation, or when the dough is removed from the freezer to be baked. Although no thawing, fermenting or proofing is needed, a consumer or user may remove the dough from the freezer some time before the dough is baked. According to embodiments, the dough can be baked directly from the frozen state. The amount of the thermostable yeast may vary based on the type of yeast used. For example, if the thermostable yeast is cream yeast, the amount of thermostable yeast in the dough may be about 1.5 to about 9 wt-%, about 2 to about 8 wt-%, or about 2.5 to about 7 wt-% based on the weight of the dough base. Cream yeast has a yeast solids content of about 18%. If the thermostable yeast is a compressed yeast, the amount of first yeast in the dough may be about 0.5 to about 7 wt-%, about 0.75 to about 6 wt-%, or about 1 to about 5 wt-% based on the weight of the dough base. Compressed yeast has a yeast solids content of about 30%. The thermostable yeast may also be a combination of yeast types.

The rheology of the dough is primarily determined by the type of flour, and the amount of flour and water in the dough. Dough rheology is also affected by other additives, such as sugar, salt, gums, stabilizers, and enzymes.

The dough may include dough conditioners or dough enhancers selected to improve the rheology of the dough and/or to improve gas holding ability. Dough conditioners can be used to enhance a dough, and in particular, improve the performance of frozen dough. The dough conditioners can include oxidative agents, reducing agents, emulsifiers, stabilizers, protein surface modifiers, and bakery enzymes. These dough enhancers are capable of modifying a variety of flour components in dough such that molecular interactions are enhanced toward and thus improve dough rheology. In one example, the dough conditioners include at least one oxidative agent, one emulsifier, and a combination of enzymes. In one exemplary embodiment, the dough is provided as a so-called cleaner label dough, and the dough conditioners include only flour (as carrier), ascorbic acid and enzymes.

The total amount of dough conditioners can be from 0 to about 10% of the dough, or from 0.01 to about 6%, or from about 0.1 to about 5% of the dough.

Suitable enzymes that can be used as dough enhancers include enzymes that are capable of hydrolyzing their corresponding substrates to enhance compatibility with proteins, starches, fibers and lipids in flour. Exemplary enzymes include protease, amylase, cellulase, xylanase, lipase, and glucose oxidase. Other enzymes, like transglutaminase can also be used to enhance protein cross-linking and therefore, dough strength.

Enzymes can be included in the dough at a concentration of 0 to about 2%, from about 0.001 to about 1%, or from about 0.01 to about 0.5%. In one exemplary embodiment, the dough includes about 0.01% (100 ppm) to about 0.10% (1000 ppm) of enzyme, such as xylanase and amylase.

Dough rheology can be improved by including protein surface modifiers that are capable of hydrophobic binding of proteins in the dough. In one example, the dough includes at least a protein surface modifier, and an oxidative agent.

Protein surface modifiers can improve the gas holding ability of the dough, and preserve gas nucleus sites in a mixed and rested dough during frozen storage. Protein modifiers, such as polysaccharides, can be used in combination with the thermostable yeast. Applicants have surprisingly found that the rising height of the bakery product was substantially increased and cell structure of the bakery product was enhanced, seen as larger and more defined air cells when compared to a bakery product without polysaccharide. Without wishing to be bound by theory, it is believed that the hydrophobic interaction between the polysaccharide and the protein provide the protein with increased accesses to water through the hydrophilic polysaccharide molecule, which can absorb much more water than can the protein. Polysaccharide and wheat protein, mainly gluten, may bind hydrophobically to create protein polysaccharide complexes in the form of films forming air cells. Such air cells have a thicker protein film since they are protein-polysaccharide complexes, and resistant to gas release, resulting in a higher gas retention. The protein-polysaccharide films also have a higher water availability, which facilitates the leavening reaction in the oven. Polysaccharides can carry water and act as a water reservoir for the protein, facilitating rheological changes in the dough. An increase in water or access to water results in a softer dough rheology, enabling the rising of the dough without excessive shrinking back, thus contributing to the rising action of the dough during baking. Water also helps the thermostable yeast and sugars in the dough disperse and dissolve, resulting in more effective creation of gas nucleus sites. The increase in water also makes the highly activated and fast leavening possible during baking in the oven, since more interactions and therefore more reactions can occur with the increase in mobility due to water availability.

Examples of protein modifiers include gums, such as propylene glycol alginates, sodium alginate, xanthan, gellan, pectin, guar gum, carrageenan, locust bean gum, gum Arabic, carboxymethyl cellulose, METHOCEL (methylcellulose and hydroxypropyl methylcellulose (hypromellose) polymers, available from The Dow Chemical Co., in Midland, Mich.), BENECEL (hydroxypropyl methyl cellulose available from Ashland Inc. in Ashland, Wis.), and the like. Examples of emulsifiers include food surfactants, such as diacetyl tartaric acid ester of mono- and diglycerides (DATEM), sodium stearoyl lactylate (SSL), mono- and diglycerides, lecithin, and the like. In some embodiments, the dough comprises one or more alginates, such as propylene glycol alginate or sodium alginate.

Protein surface modifiers can be included in the dough at a concentration of 0 to about 2%, from about 0.1 to about 1%, or from about 0.1 to about 0.5%. In one exemplary embodiment, the dough includes about 0.1 to about 0.3% of alginate, such as propylene glycol alginate or sodium alginate.

Suitable oxidative agents include ascorbic acid, potassium bromate, azodicarbonamide, and glycose oxidase. Oxidative agents can be used to enhance cross-linking of the gluten matrix by increasing the number of disulfide bonds. Oxidative agents can be included in the dough at a concentration of 0 to about 1%, or from about 0.001 to about 0.1%. In one exemplary embodiment, the dough includes about 0.005 to about 0.05% of ascorbic acid.

Referring again to FIG. 2, the dough composition is prepared by mixing together the ingredients for the dough base and the thermostable yeast. The mixing may be done by mixing the dry ingredients (e.g., flour, salt, and other dry ingredients) separately, and then mixing the dry ingredients with the wet ingredients (e.g., water, cream yeast). The mixing may include a kneading step. For example, the dough can be mixed in a stand mixer for about 5 to 15 minutes, or about 7 to 12 minutes. The dough can be first mixed at a low speed for a first length of time (e.g., about 1 minute), and then at a medium or high speed for a second length of time (e.g., about 6 or 7 minutes). Dough for bread may be mixed longer, about 8 to 12 minutes.

The dough is shaped into a desired shape in a make-up step. Exemplary shapes include a bread loaf, sandwich bread (e.g., a loaf baked in a pan), boule, baguette, Italian bread, rolls, buns, bread sticks, pup loaves, pizza crust, flat bread, etc. If the dough is shaped into pizza crust or flat bread, it may be mechanically sheeted and cut into shape, or it can also be pressed into desired forms. The dough is then allowed to rest for a period of time, e.g., for about 1 to 45 minutes, about 2 to about 30 minutes, or for about 5 to about 20 minutes, prior to freezing. The resting period is long enough that gas nuclei form in the dough, but not so long that the dough begins to ferment. The resting can be done at room temperature, or at about 60 to about 85° F. (about 15.5 to about 29.5° C.), or at about 60 to about 75° F. (about 15.5 to about 24° C.). Due to the activity of the thermostable yeast at lower temperatures (compared to ordinary, non-thermostable yeast), the dough composition can be rested at a lower temperature, e.g., at about 50 to about 70° F. (about 10 to about 21° C.), at about 55 to about 70° F. (about 12 to about 21° C.), or at about 60 to about 68° F. (about 15.5 to about 20° C.). Resting the dough at temperatures higher than 70° F. may result in a lower quality final product (e.g., lower rise and less appealing appearance) due to loss in yeast vitality during frozen storage.

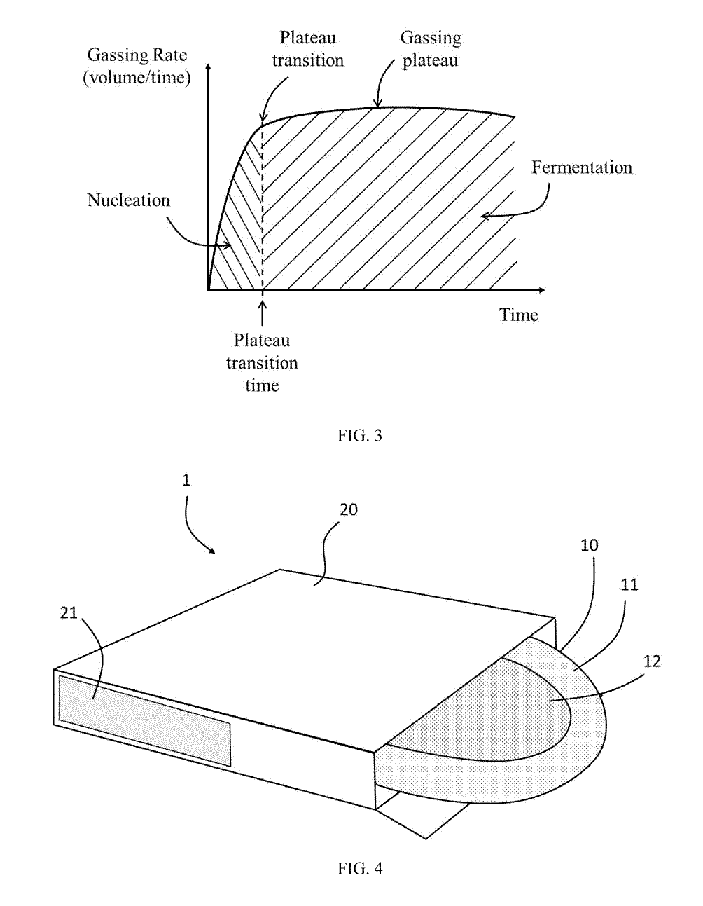

In some embodiments, the length of the resting period is determined based on the time it takes to reach the gassing plateau (referred to here as plateau transition time). For example, the resting period may be approximately equal to the plateau transition time, or may be within about ±5%, about ±10%, about ±15%, about ±20%, about ±30%, or about ±50% of the plateau transition time, or ranges from about 20% of the plateau transition time to about 200% of the plateau transition time. The gas nucleation, plateau transition time, and gassing plateau are schematically shown in FIG. 3.

In exemplary embodiments, the plateau transition time may be from about 10 to about 60 minutes, or from about 15 to about 30 minutes, determined by a Risograph test under similar conditions as the conditions for resting. The time to reach the gassing plateau can be measured by finding the plateau transition as a function time from a very high gassing rate to a low gassing rate, where gassing transitions from a sharp increase in the gassing rate to a steady gassing rate (see FIG. 3).

Resting the dough until the yeast reaches the plateau transition allows for full nucleation development in the dough, without significant fermentation occurring. This provides the dough with sufficient air cells for leavening during baking in the oven, while reducing the loss of yeast vitality during frozen storage that can happen due to fermentation or proofing prior to freezing.

In one exemplary embodiment, the rested dough includes air cells that are smaller than 5 mm in diameter. For example, at least 75% of the air cells may be smaller than 5 mm, smaller than 4 mm, smaller than 3 mm, or about 2 mm or smaller in diameter. In some embodiments, at least 90% of the air cells in the rested dough (and subsequently, in the frozen dough) are smaller than 5 mm, smaller than 4 mm, smaller than 3 mm, or about 2 mm or smaller in diameter.

Applicants have surprisingly discovered that when the dough is allowed to rest at room temperature (about 60 to about 70° F. (about 15.5 to about 21° C.)) until at least the plateau transition time and freezing the dough without fermentation or proofing, the dough rises well during baking to provide a fresher appearance. If the dough made with thermostable yeast was fermented and proofed before freezing, the quality of the resulting bakery item deteriorated after frozen storage.

The resting can have a minor impact on the thickness of the dough. In some aspects, the sheeted dough (e.g., pizza crust) has a first thickness, and the rested dough has a second thickness. The second thickness (i.e., the thickness of the rested dough) is no more than 50% greater than the first thickness (i.e., the thickness of the sheeted dough), no more than 30% greater than the first thickness, or no more than 20% greater than the first thickness.

In an embodiment, the non-proofed dough is frozen. In some embodiments, the dough is frozen to a temperature of about −40 to about 20° F. (about −40 to about −6.5° C.), about −35 to about 10° F. (about −37 to about −12° C.), about −30 to about 0° F. (about −34.5 to about −18° C.), or about −25 to about −10° F. (about −31.5 to about −23° C.) (e.g., about −20° F., or about −29° C.). Preferably, the dough is frozen quickly, for example by blast freezing the dough to about −25 to about −15° F. (about −31.5 to about −26° C.) in about 25 to 40 minutes. The frozen proofed dough can be stored frozen at a temperature of about −40 to about 20° F. (about −40 to about −6.5° C.), about −35 to about 10° F. (about −37 to about −12° C.), about −30 to about 0° F. (about −34.5 to about −18° C.), or about −25 to about −10° F. (about −31.5 to about −23° C.) (e.g., about −20° F., or about −29° C.).

Thermostable yeast can survive subfreezing temperatures below 0° F. when it is intact. However, the vitality of thermostable yeast can decrease sharply if the yeast has been activated, e.g. in a proofed dough or a fermented dough. The frozen dough includes viable thermostable yeast cells because the dough has not gone through proofing or any significant fermentation steps. A small portion of the yeast cells may die during frozen storage. However, at least about 75%, about 80%, about 85%, about 90%, or about 95% of the yeast cells are viable in the frozen dough after about 2 to about 12 weeks of frozen storage.

In some embodiments, the bakery product is a pizza. In making a pizza, the shaped dough can be topped with pizza toppings (e.g., sauce, cheese, and other suitable toppings) either before or after freezing. A variety of tomato based or other sauces, and a variety of cheeses and cheese blends can be used in combination with toppings selected from meat sources, fish sources, vegetable sources, or fruit sources or other typical topping materials. Pizza sauces can include a variety of ingredients including tomato portions, tomato sauce, tomato paste, white sauces (e.g., cheese sauce or garlic sauce), pesto, and seasonings including salt and spices. Cheeses can include mozzarella, Romano, Parmesan, jack and others. Commonly, cheeses in the form of shaved, crumbled or string form derived from mozzarella, Romano, Parmesan, provolone and whole milk or non-pasteurized cheeses can be used. Cheeses and cheese blends can be used both in the form of blended materials wherein two or more cheeses are blended and then applied to the crust. However, cheeses can also be added to the crust in layers without premixing.

Various meats, including Italian sausages, pepperoni, prosciutto, chicken, bacon, beef, and seafood such as shrimp, mussels, fish, etc. can be used to form the pizza product. Suitable vegetable toppings include spinach, mushrooms, onions, garlic, bell peppers, artichokes, tomatoes, leafy greens, corn, etc. Fruit materials can also be used on the pizzas, both in a vegetarian and non-vegetarian form. Examples of fruit materials include pineapples, apples, etc. Examples of pizza products prepared according to the disclosure include Italian style pepperoni pizzas with a blended cheese topping; Italian cheese pizzas having no other meat toppings but optionally including vegetable add-ons; classic supreme pizzas including pepperoni, Italian sausage, green pepper, onion, and/or mushrooms; and southwest chicken pizzas including grilled chicken, Mexican salsa, corn, beans, and other Tejano or Mexican seasonings. A spinach and roasted mushroom pizza can also be made using rough-cut spinach and chopped and roasted mushrooms. Lastly, a bacon and blended cheese of Italian origin including mozzarella, Parmesan, and Romano can be made.

The bakery products (e.g., baguette, Italian bread, rolls, buns, bread sticks, pup loaves, pizza crust, assembled pizza with toppings, flat bread, etc.) can be packaged using conventional methods and stored frozen. The frozen bakery products may be shipped or delivered to retail outlets and maintained in frozen condition in freezer chests for purchase. The frozen products can also be converted to refrigerated products by thawing in a refrigerator and sold as deli or refrigerated dough items. Consumers can purchase the frozen bakery products and can maintain them at home in a frozen state until cooked. Alternatively, the bakery products can be used by bakeries, restaurants, cafeterias, stores, or institutional kitchens. The frozen bakery products can be delivered to users frozen with instructions to bake the product without thawing, fermenting, or proofing.

A schematic depiction of a packaged product 1 is shown in FIG. 4. The packaged product 1 includes the frozen bakery product 10 and a packaging 20. The frozen bakery product 10 includes a dough 11 (e.g., a dough crust) and optionally toppings 12. Any suitable packaging can be used, such as plastic, paper, paperboard, cardboard, or a combination thereof. The packaging 20 may include instructions 21 for the end user to bake the product without proofing or fermentation. The instructions 21 may also instruct the end user to bake the frozen product without thawing.

In some embodiments, the product may be smaller in size than a fermented and proofed counterpart, but will bake to a higher rising final bakery product with a fresher appearance.

Commonly, the bakery products are removed from packaging materials and placed in an oven and cooked at a temperature suitable for the particular product. For example, bread loaves can be cooked at a temperature of about 375° F. to about 450° F. (about 190 to about 232° C.), or about 400 to about 425° F. (about 204 to about 218° C.), for about 20 to 60 minutes, or for about 25 to 45 minutes. Smaller items, such as rolls can be cooked at a temperature of about 350° F. to about 440° F. (about 177 to about 227° C.), or about 375 to about 400° F. (about 190 to about 204° C.), for about 12 to about 30 minutes, or for about 15 to about 20 minutes. Flat breads and pizzas can be cooked at a temperature of about 375° F. to about 500° F. (about 190 to about 260° C.), or about 375 to about 425° F. (about 190 to about 218° C.), for about 15 to 35 minutes, or for about 20 to 30 minutes. In one exemplary embodiment, the dough is baked at about 400° F. In some embodiments, baking is done at a lower temperature, for example, at about 375° F. (about 190° C.). When the dough is baked at 375° F. (190° C.) rather than 400° F. (204° C.), higher rising is observed.

According to an embodiment, the frozen bakery product is baked directly from the frozen state without significantly thawing the frozen bakery product. Some thawing may occur in practice when the product is transferred from a freezer to the oven, or due to a time lag after being taken out of the freezer and before being placed in the oven. The suitable baking temperature and time can be adjusted for the temperature of the product.

Applicants have surprisingly found that thermostable yeast produces a much higher amount of total gases during the course of baking than ordinary yeast. Without wishing to be bound by theory, it is hypothesized that the performance of thermostable yeast is due to a higher gassing power, an earlier and faster initiation of gassing at a lower temperature, as well as higher gassing power and higher heat tolerance and endurance during baking. However, at least some of the benefits were lost if the dough was fermented or proofed prior to frozen storage.

Yeast activity increases as temperature increases before the death point, where yeast is deactivated. Thermostable yeast has a higher gassing power and survives longer over a wide range of temperatures, and produced more gases during baking when the product is transferred from a freezer to an oven for baking. The available time window for the yeast to leaven the product was found to increase from about 3 minutes to about 6 minutes at 400° F. (204° C.), as the dead point was increased from about 142° F. (61° C.) (ordinary yeast) to about 163° F. (73° C.) (thermostable yeast).

Due to the action of live yeast during baking, the resulting bakery products have a fresher appearance as compared to similar products made with regular yeast. A fresher appearance can be understood to mean a fuller crust with a shinier surface and more natural browning color.

In the embodiments, the dough has a first volume before resting, a second volume after resting, and a third volume after baking. The volume of the dough here refers to the volume of a particular segment of dough, such as, for example, a made-up segment of dough that will be baked into a loaf of bread, a roll, or a pizza crust, etc. During resting, the dough is not allowed to ferment (e.g., proof), but some formation of gas nuclei may occur, and thus a minimal increase in the dough volume may occur. According to some embodiments, the second volume is no more than 50% greater than the first volume. For example, the second volume may be about 2-40% greater than the first volume, about 15% greater, about 10% greater, or about 5% greater, than the first volume. The volume after freezing may be the same or slightly lower than the second volume, as the dough may lose some volume during freezing. However, according to an embodiment, the volume is recovered due to activation of the thermostable yeast in the oven. The frozen dough comprises gas nuclei, which may make up about 5 to about 50%, about 10 to about 40%, or about 15 to about 30% of the volume of the frozen dough (e.g., the second volume). The third volume (volume after baking) may be at least 25 to about 100% greater than the second volume. For example, the third volume may be about 75 to about 400% greater, about 100 to about 300% greater, or about 150 to about 250% greater than the second volume.

### EXAMPLES

Various embodiments of the composition and method according to the present disclosure were tested in the following examples. Unless otherwise indicated, dough formulations were mixed by mixing together dry ingredients and then mixing wet ingredients with the dry ingredients. The dough formulations were mixed for 1 minutes at low speed and 7 minutes at high speed.

Ingredients:
Yeasts:
   Thermostable yeast (solid content about 80%)
   Crumbled compressed yeast (solids content 34%)
   Frozen yeast (solids content about 80%)
Oils and fats
Dough enhancers: ascorbic acid, enzymes, DATEM (diacetyl tartaric acid ester of mono-diglyceride), propylene glycol alginate.

Equipment:
Mixers, sheeter, oven
Differential scanning calorimeter available from PerkinElmer in Waltham, Mass.
Risograph (available from The National Manufacturing Co. in Lincoln, Nebr.)

### Example 1

The thermal properties and thermal stability of various yeasts were analyzed by a differential scanning calorimeter (DSC). The solid content of the tested yeasts was analyzed using a moisture analyzer, and all yeasts were diluted to a moisture content of that of the compressed yeast so that comparison can be made on the same solid content basis. Compressed yeast, which had a moisture content of 65%, was analyzed without any further dilution (as is). Other types of yeast, including, protected active dry yeast, instant yeast, thermostable yeast and frozen yeast were diluted to a moisture content of 65%. Dilution was done by manually stirring the yeast with water in a 10 mL glass vial for about 30 seconds until the yeast was well hydrated and mixed. The samples were covered and allowed to rest for 30 minutes at room temperature (71° F., about 21.5° C.) before performing the DSC analysis.

During the DSC analysis, samples were scanned from a start temperature of −60° C. to 100° C. at a rate of 5° C./min. A second scan was made to confirm the protein peak which was irreversibly denatured during the first scan. The initial solid content and water dilution factors are shown in TABLE 1.

TABLE 1
Solid content of and dilution of yeast samples.

| | Initial Solid | Water Added to | End Moisture |
|---|---|---|---|
| | Content (%) | 1.00 g Yeast | Content (%) |
| Compressed Yeast | 35.0 | 0 | 65 |
| Protected Active Dry | 95.0 | 1.71 | 65 |
| Yeast | | | |
| Instant Yeast | 95.0 | 1.71 | 65 |
| Thermostable Yeast | 78.9 | 1.27 | 65 |
| Frozen Yeast | 80.6 | 1.25 | 65 |

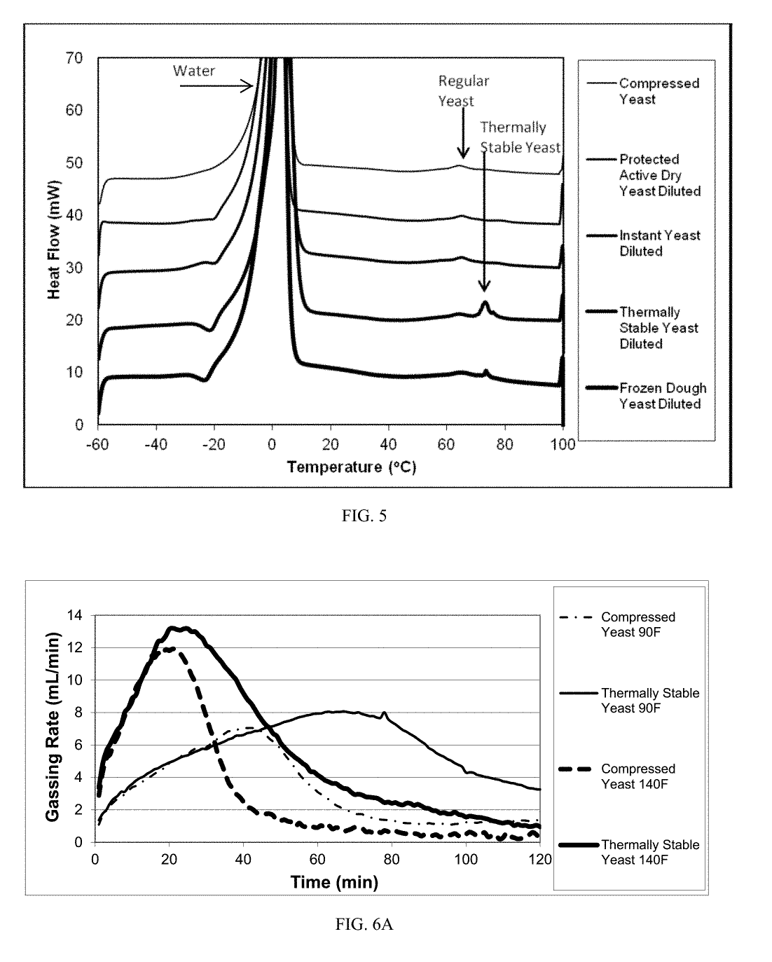

The DSC thermograms of various yeasts are given in FIG. 5. The denaturation peak temperature and enthalpy of the yeasts are given in TABLE 2. The larger peak seen in the DSC thermograms shows the melting of water in the samples, and the smaller peak between 60-80° C. shows the thermal degradation temperature of the yeast.

TABLE 2
Denaturation Peak Temperature and Enthalpy of Various Yeasts.

| | Water | | Protein Peak | | | |
|---|---|---|---|---|---|---|
| | Peak | | Peak | Onset | End | |
| | Temp | Enthalpy | Temp | Temp | Temp | Enthalpy |
| Sample | (° C.) | (ΔH, J/g) | (° C.) | (° C.) | (° C.) | (ΔH, J/g) |
| Compressed Yeast | 3.10 | 254.4 | 64.30 | 58.98 | 68.32 | 5.20 |
| Protected Active | 1.09 | 239.3 | 65.05 | 60.49 | 70.00 | 5.29 |
| Dry Yeast | | | | | | |
| Instant Yeast | 4.17 | 243.3 | 65.10 | 59.98 | 70.59 | 5.30 |
| Thermostable Yeast | 3.01 | 256.4 | 73.01 | 60.57 | 75.26 | 10.98 |
| Frozen Yeast | 2.35 | 250.5 | 73.48 | 60.05 | 75.04 | 6.71 |

Results from DSC test of various yeasts indicated that regular yeast, including compressed yeast, protected active dry yeast, and instant yeast had similar protein denaturation peak temperatures and enthalpies at around 65° C. and 5.30 J/g, respectively. In contrast, the thermostable yeast and the frozen yeast had much higher protein denaturation temperatures at around 73.0° C. and enthalpies ranging from 6.71 to 10.98 J/g than the regular yeasts. Additionally, the thermostable yeast had a much higher denaturation enthalpy (10.98 J/g) than that of the frozen yeast (6.71 J/g). The higher denaturation temperature indicates a higher thermal stability and a higher enthalpy indicates a higher degree of protein conformational changes during heating. This suggested a higher death point of the yeast and, therefore, a higher leavening action to produce gases during baking in the oven.

Overall, the thermally stable yeasts (thermostable yeast and frozen yeast) had a denaturation temperature higher, about 8° C. (about 16° F.), than the compressed yeast, the rehydrated protected active dry yeast and the instant yeast. In addition, the thermostable yeast had a higher denaturation enthalpy than the frozen yeast with a difference of about 4 J/g.

### Example 2

Dough formulations were prepared. A control sample was prepared using compressed yeast, and a test sample using thermostable yeast. The gassing rate and total gas volume of the formulations were evaluated using a Risograph.

The samples were prepared according to a standard method described in AACC Method 89-01.01 (American Association of Cereal Chemists). Dough mixing was done using a Farinograph set at a water bath temperature of 70° F.

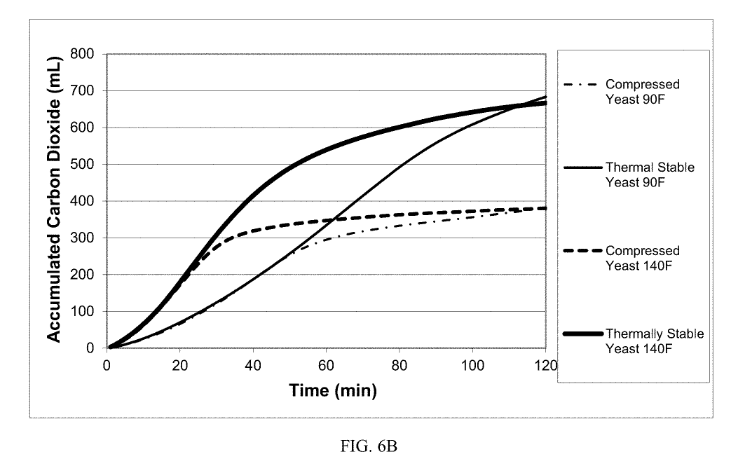

Dough samples of 50 g each were placed in the Risograph, and the gassing rate and total gas volume were evaluated at a water bath temperatures of 90° F. and 140° F., respectively. Results of the Risograph test are shown in FIGS. 6A and 6B.

It was observed that the test dough prepared with thermostable yeast exhibited gassing more steadily over a longer period of time than the compressed yeast at both water bath temperatures, as shown by a higher maximal gassing rate and a larger total carbon dioxide volume.

### Example 3

Dough formulations were prepared. Thermostable yeast was used in the test sample, and compressed yeast was used in the control sample. The temperature of the dough after mixing and the temperature of the Risograph water bath were adjusted to simulate the conditions of an actual pilot plant production. Leavening time, the time needed to reach full gas nucleation, was determined by measuring the transition in gassing rate in dough, and recorded as the time required to reach the gassing plateau in a Risograph.

The samples were prepared according to a standard method described in AACC (American Association of Cereal Chemists) Method 89-01.01. Dough mixing was done using a Farinograph set at a water bath temperature of 75° F. This temperature was used to simulate the dough temperature in pilot plant production.

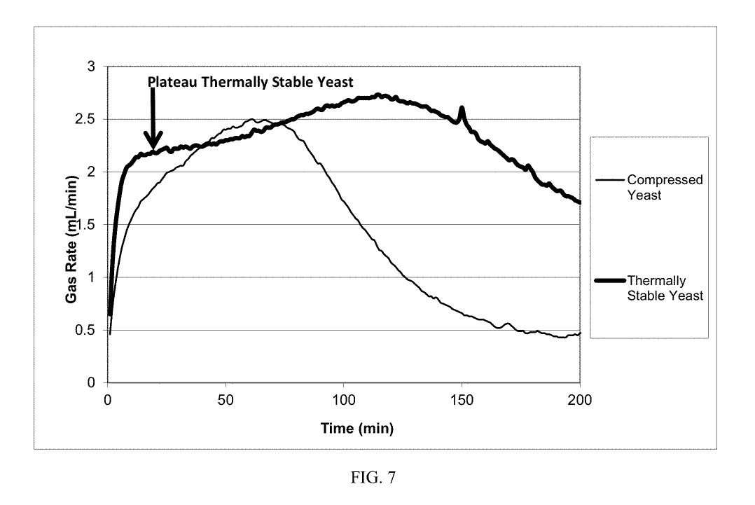

Dough samples of 50 g each were placed in the Risograph, and the gassing rate was evaluated at a water bath temperature of 65° F. This temperature was used to simulate the pilot plant room temperature during resting of dough according to embodiments. Results of the Risograph test are shown in FIG. 7.

It was observed that the test dough prepared with thermostable yeast exhibited a higher gassing rate that began earlier than the control dough. A plateau gassing point was found to be at about 17 minutes, thereafter, the instantaneous gassing rate transitioned into a slow rate seen as the plateau. This time corresponds to the time that produces maximal gas nucleation sites in dough without any significant fermentation occurring.

It was also observed that the control dough prepared with compressed yeast had a lower gassing rate and shorter duration overall, and required significantly more time to reach the gassing plateau at about 67 minutes.

### Example 4

Three dough formulations were prepared and made into pup loaves and pizza crusts to test the rising of non-proofed formulations.

Dough formulations of about 4980 g each were prepared according to TABLE 3 using a stand mixer. Formulation A was prepared with compressed yeast, formulation B was prepared with thermostable (frozen) yeast, and formulation C was prepared with a combination of thermostable yeast and sodium bicarbonate (baking soda). The compressed yeast was crumbled and then mixed into the dough with the wet ingredients, while the frozen thermostable yeast and sodium bicarbonate were mixed into the dough with the dry ingredients. After mixing, the temperature of the dough formulations was about 75-77° F.

TABLE 3
Rising Comparison

| | | | | | Formulation C | |
|---|---|---|---|---|---|---|
| | Formulation A | | Formulation B | | (Thermostable + | |
| | (Compressed) | | (Thermostable) | | soda) | |
| Description | Grams | Wt-% | Grams | Wt-% | Grams | Wt-% |
| Wheat Flour | 3000.0 | 60.2% | 3000.0 | 60.2% | 3000.0 | 59.6% |
| Sourdough | — | — | — | — | 60.0 | 1.2% |
| Flavor | | | | | | |
| Water | 1552.0 | 31.2% | 1552.0 | 31.2% | 1533.0 | 30.4% |
| Salt | 70.7 | 1.4% | 70.70 | 1.4% | 70.7 | 1.4% |
| Sugar | 90.0 | 1.8% | 90.0 | 1.8% | 90.0 | 1.8% |
| Compressed | 153.0 | 3.1% | — | — | — | — |
| Yeast | | | | | | |
| Thermostable | — | — | 153.0 | 3.1% | 153.0 | 3.0% |
| Yeast | | | | | | |
| Sodium | — | — | — | — | 15.0 | 0.3% |
| Bicarbonate | | | | | | |
| Shortening | 114.0 | 2.3% | 114.0 | 2.3% | 114.0 | 2.3% |
| Dough | 0.99 | 0.02% | 0.99 | 0.02% | 0.99 | 0.02% |
| Enhancers | | | | | | |
| Total | 4981.0 | 100% | 4981.0 | 100% | 5036.0 | 100% |

Frozen Pizzas After Baking

| | | | |
|---|---|---|---|
| Appearance | Unleavened dense | Golden browning | Tan like |
| and cell | edge, minimal | edge, good rising, | appealing |
| structure | rising, dense cells | open cells | browning, good |
| | | | rising, open cells |
| Weight (g) | 733.5 | 738.0 | 757.0 |
| Thickness | 8.0 | 14.0 | 15.0 |
| (mm) | | | |
| Width (inch) | 10.75 | 11.5 | 11.5 |
| Length (inch) | 11.5 | 11.5 | 11.75 |

The dough was sheeted, folded, and cut to 450 g pizza crusts with a 12-inch cutter. The crusts were rested at room temperature (65° F.) for 20 minutes. The crusts were then blast frozen and stored at −20° F. overnight. After one day of frozen storage, all the crusts were topped with 170 g pizza sauce and 220 g mozzarella cheese creating pizzas. These pizzas were then placed back into frozen storage at −20° F. until use.

After one week of frozen storage, the pizzas were tempered from −20° F. to 0° F. overnight. The pizzas were then baked at 400° F. for 22 minutes. The finished pizzas were evaluated for crumb cell structure, rise, and appearance, as shown in TABLE 3.

As shown in TABLE 3, the rising height of the three products after baking were, 8.0, 14.0 and 15.0 mm, respectively. It was observed that Formulation A resulted in a poorly risen, dense pizza crust characterized by an unleavened edge with tough, dense dough mass. Formulations B and C exhibited good rises with open cells and an acceptable tender bite when eating. Formulation B had golden brown edges and appeared similar to a freshly baked bakery product prepared from proofed dough. Formulation C also produced an appealing crust with a tannish brown edge and alkaline flavor, similar to a freshly baked pretzel crust but with less of flavor and color intensity.

### Example 5

Three dough formulations were prepared to test the performance of three different yeasts. These yeasts were tested by subjecting the dough formulations to different rest times, as well as, proofed and non-proofed processes. All of the fresh dough products were baked directly without frozen storage.

Three dough formulations of about 1756 g were prepared according to TABLE 4 using a stand mixer. Formulation D was prepared with compressed yeast, formulation E was prepared with thermostable yeast, and formulation F was prepared with frozen yeast. The compressed yeast was crumbled and then mixed into the dough with the wet ingredients, while the thermostable yeast and frozen yeast were mixed into the dough with the dry ingredients. After mixing, the temperature of dough formulations was about 77-78° F.

TABLE 4
Yeast Performance Comparison

| | Formulation D | | Formulation E | | Formulation F | |
|---|---|---|---|---|---|---|
| | (Compressed) | | (Thermostable) | | (Frozen Yeast) | |
| Description | Grams | Wt-% | Grams | Wt-% | Grams | Wt-% |
| Wheat Flour | 1000.0 | 56.9% | 1000.0 | 56.9% | 1000.0 | 56.9% |
| Water | 613.0 | 34.9% | 613.0 | 34.9% | 613.0 | 34.9% |
| Salt | 23.6 | 1.3% | 23.6 | 1.3% | 23.6 | 1.3% |
| Sugar | 30.0 | 1.7% | 30.0 | 1.7% | 30.0 | 1.7% |
| Compressed | 51.0 | 2.9% | — | — | — | — |
| Yeast | | | | | | |
| Thermostable | — | — | 51.0 | 2.9% | — | — |
| Yeast | | | | | | |
| Frozen Yeast | — | — | — | — | 51.0 | 2.9% |
| Shortening | 38.0 | 2.2% | 38.0 | 2.2% | 38.0 | 2.2% |
| Dough | 1.1 | 0.06% | 1.1 | 0.06% | 1.1 | 0.06% |
| Enhancers | | | | | | |
| Total | 1756.0 | 100% | 1756.0 | 100% | 1756.0 | 100% |

Pup-loaf Bread After Baking

| Appearance | Unleavened dense | Good rising loaf, | Some rising, |
|---|---|---|---|
| and cell | loaf, compact cell | open cells | somehow |
| structure | | | compact cells |
| Pup-loaf | | | |
| Bread Specific | | | |
| Volume (cc/g) | Specific Volume (cc/g) | | |
| 20 min Rest | 2.94 | 3.65 | 3.54 |
| Non-Proof | | | |
| 30 min Rest | 3.44 | 4.38 | 3.93 |
| Non-Proof | | | |
| Proofed | 6.48 | 6.16 | 5.74 |

Each test was performed in duplicate for each of the three dough formulations. Therefore, a total of six 170 g pup loaves were formed and placed into pup loaf pans. Prior to baking each set of pup loaves were subjected to different conditions. The first set of pup loaves were rested at room temperature for 20 minutes. The second set of pup loaves were rested at room temperature for 30 minutes. The third set of pup loaves were proofed at 110° F., in 85% relative humidity until risen 1 inch above the edge of the pan (49 minutes for Formulation D, and 35 min for Formulations E and F). The test area room temperature was 65° F. All loaves were baked at 400° F. for 25-30 minutes, until golden brown.

After baking, the pup loaves were cooled for about 20 minutes at room temperature before the weight and volume of each loaf were measured. The specific volume of each pup loaf was calculated as the loaf volume over loaf weight and expressed as cubic centimeter per gram (cc/g). The pup loaves were then evaluated by appearance and cross cut to evaluate the cell structure in the final bread products. The results of pup loaf evaluations are given in TABLE 4.

Formulation E (thermostable yeast) produced the highest risen bread product after both the 20 minute and 30 minute rests. It was observed that 30 minute Formulation E rest was able to produce a risen bread product with a similar rise to those achieved by fully proofing the dough. Formulation F (frozen yeast) produced the second highest risen bread product and Formulation D (compressed yeast) produced the lowest risen product. The specific volumes of the pup loaves for the three formulations were 2.94, 3.65 and 3.54 cc/g for the 20 minute rest, and 3.44, 4.38 and 3.93 for the 30 minute rest. It was observed that all of the proofed formulations produced similar risen bread products, however, Formulation D required longer proofing times than Formulations E and F.

It was concluded that thermostable yeast produced the highest rise for the non-proofed dough formulations. It was also concluded that thermostable yeast in a non-proofed dough formulation achieved the closest results to those achieved by a fully proofed dough.

### Example 6

Two dough formulations were prepared to test the performance of a thermostable yeast in non-proofed, frozen pizza. Each dough formulation was prepared and shaped into a pizza crust, stored frozen, topped, and baked. The products were evaluated by texture and rising height.

The two dough formulations were prepared according to TABLE 5 (Formulation G) using a stand mixer. A control was similarly prepared but the amount of yeast was adjusted to account for the different solid content of compressed yeast (Formulation H).

TABLE 5
Performance of Thermostable Yeast in Non-Proofed Frozen Pizza

| | |
|---|---|
| Formula G | Formula H |
| Thermostable | Compressed |
| Yeast | Yeast |

| Description | Grams | Wt-% | Grams | Wt-% |
|---|---|---|---|---|
| Hard Wheat Flour | 3000.1 | 58.57 | 3000.2 | 58.58 |
| Water | 1650.2 | 32.22 | 1444.7 | 28.21 |
| Compressed Yeast | | | 365.6 | 7.14 |
| Thermostable Yeast | 160.2 | 3.13 | | |
| Propylene Glycol | 10.2 | 0.20 | 10.2 | 0.20 |
| Alginate | | | | |
| Datem | 15.4 | 0.30 | 15.4 | 0.30 |
| Ascorbic Acid | 0.5 | 0.01 | 0.5 | 0.01 |
| Dough Enhancers | 33.3 | 0.65 | 33.3 | 0.65 |
| Sugar | 59.6 | 1.16 | 59.6 | 1.16 |
| Salt | 71.7 | 1.40 | 71.7 | 1.40 |
| Shortening | 120.6 | 2.35 | 120.6 | 2.35 |
| Total | 5121.8 | 100.00 | 5121.8 | 100.00 |

Flour and other dry ingredients (salt, sugar, and dough enhancers) were mixed for 1 minute at a low speed (45 rpm). The remaining ingredients were then added. Yeast and water (55° F.) were added to both formulations and the dough was mixed at a low speed (45 rpm) for 1.5 minutes, followed by a high speed (80 rpm) mixing for 7 minutes. After mixing, the dough temperature was about 80° F. The mixed dough was then sheeted and cut to crusts of 450 g with a central cross sectional thickness of about 5 mm and a diameter of about 11.0 inches.

These sheeted and cut dough crusts were not proofed. Instead, the crusts were covered with a plastic bag and allowed to rest at room temperature (65° F.) for 20 minutes. The crusts were then blast frozen and stored at −20° F. overnight. Both the control (Formulation H) and test (Formulation G) crusts were then topped with 150 g of tomato sauce and 200 g of mozzarella cheese creating pizzas. These pizzas were then placed back into frozen storage at −20° F. overnight and then transferred to a 0° F. freezer until use.

After 2 months of frozen storage at 0° F., the control (Formulation H) and test pizzas (Formulation G) were baked in a conventional oven at 400° F. for 22-24 minutes. The finished pizzas were cross cut for evaluation of air cell structure and rising height.

The rising height of the control (Formulation H) was 9.0 mm, whereas the rising height of test (Formulation G) was 16.0 mm. It was also observed that Formulation G produced a crust with more open and larger cells. Formulation H, produced smaller and denser cells.

It was concluded that a thermostable yeast can be used to produce a non-proofed, ready-to-bake frozen dough which can be baked directly from the freezer. The thermostable yeast also produced a superior quality product as compared to the non-proofed control using compressed yeast.

### Example 7

Two dough formulations were prepared to test the consumer acceptance of embodiments of the present disclosure. This test was performed by a sensory evaluation of the a non-proofed dough formulation pizza and a conventional proofed formulation pizza.

The dough formulations were prepared and made into pizzas as in Example 5. The test dough (Formulation J) was prepared according to Formulation G in TABLE 5 and was not proofed. A control (Formulation I) was also prepared according to Formulation G, however the thermostable yeast was replaced with compressed yeast and the control was proofed. After 2 months of frozen storage at 0° F., pizza products were prepared out of each formulation as described in Example 5. The samples were coded with three digital numbers and presented blindly to panelists. These panelists were trained to evaluate freshness liking, rising height, appearance, texture, and aroma impressions. Results of the panelists' sensory evaluation are summarized in TABLE 6.

TABLE 6
Summary of Sensory Evaluation.

| | | Test Sample |
|---|---|---|
| | Control | (non-proofed, |
| | (proofed, Formulation I) | Formulation J) |
| | Freshness Liking Score | |
| | (1-5, 1 = Dislike, 5 = Like) | |
| Average (N = 21) | 2.9 | 3.8 |
| | Thickness (mm) | |
| Average (N = 3) | 12.6 | 17.8 |
| | Baked Appearance Comments | |
| Observations | Slightly light/pale, less rising, | More browning, more |
| | crust had shaper | rise, fuller crust |
| | edge/wrinkles | |
| | Texture Score Comments | |
| Observations | Thinner, chewy, tough bite | Thicker, open cells, |
| | | soft bite |
| | Flavor/Aroma Comments | |
| Observations | Yeasty, salty, fresh bread | Fresh bread, yeasty, |
| | | plain |

It was observed that Formulation J (non-proofed, thermostable yeast) received a much higher freshness liking score than the control (3.8 vs. 2.8). Formulation J also had a much higher rising height than the control (17.8 mm vs. 12.6 mm). Formulation J received comments that indicated a fuller, smooth and higher rising appearance, and comments of a thicker and softer bite texture than the control. The panelist noted that the control was wrinkly with lower rising, and commented that the bite texture of the control was thin and tough.

The panelists found Formulation J to be browner and richer in color than the control, Formulation I. It is hypothesized that thermostable yeast produces a stronger leavening action during baking in the oven from during oven baking. This difference in leavening, without proofing or fermentation, contributed to the fresher appearance and color differences observed by the panelists. The color difference may also be attributed a richer sugar content in the non-proofed dough, as sugar is consumed during proofing.

It was concluded that a thermostable yeast produced a non-proofed frozen dough which can be baked directly from a frozen state and produce a fresher, superior quality pizza when compared to the control using a proofing step.

### Example 8

Two dough formulations were prepared to compare the air cell sizes of a proofed dough prepared with compressed yeast versus a non-proofed dough prepared with thermostable yeast. These dough formulations were subjected to C-cell analysis, which is used to quantify the open cell structure of a product by measuring cell size distribution in the product. Cell size non-uniformity (or unevenness) is defined as a measure of the lack of uniformity between fine and course texture (including holes) across a slice of dough or bread. C-cell analysis was performed using the C-Cell Imaging System manufactured by Calibre Control International, Ltd. in Warrington, UK.

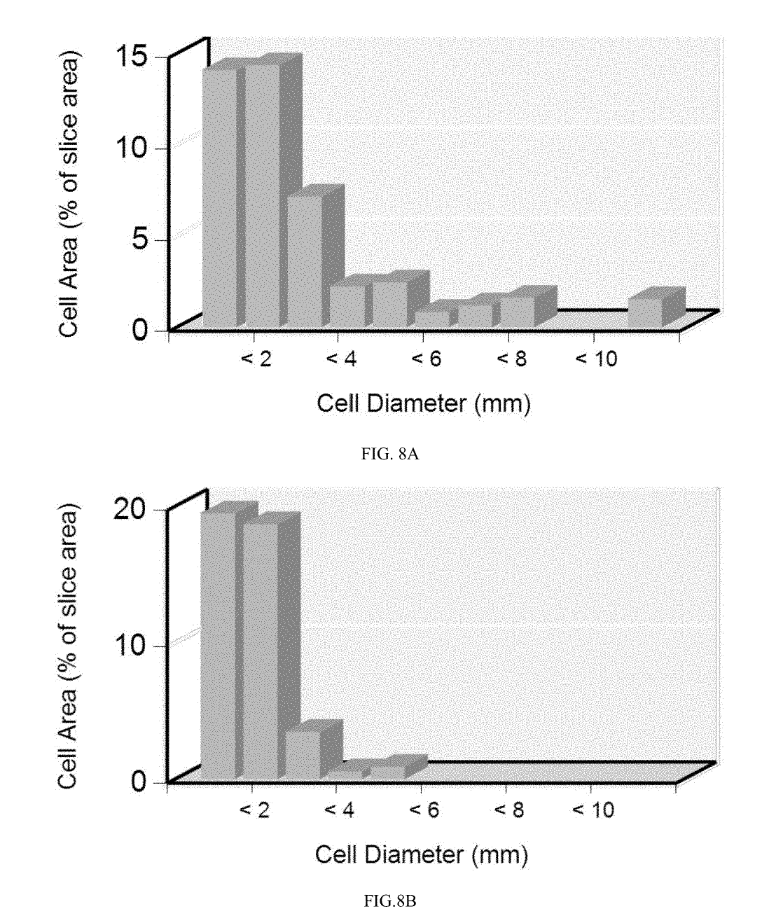

The control (Formulation K) was prepared as Formulation H in Example 6. The test sample (Formulation L) was prepared according to Formulation G in Example 6. Batch sizes of 350 g were used to prepare the dough formulations. Each dough formulation was prepared using a Farinograph set at 70° F. The doughs were mixed for 6 minutes in the Farinograph. After mixing, petri dishes were prepared with round discs of dough weighing 15 g each. The control (Formulation K) was proofed for 50 minutes at 95° C. with 75% relative humidity. The test sample (Formulation L) was allowed to rest for 20 minutes at ambient temperature (70° F.). The samples were then evaluated using the C-Cell Imaging System. Images of the samples and results of the analysis as cell area (% of slice area) as a function of cell diameter (mm) are shown graphically in FIGS. 8A (Formulation K) and 8B (Formulation L).

C-cell analysis suggested a physically, and chemically more stable dough mass when the dough is not proofed than when it is proofed. It was observed that the proofed dough formulation (Formulation K) had larger cells with uneven cell sizes. The cell sizes ranged from 0 to 10 mm. Comparatively, the rested non-proofed dough formulation (Formulation L) included smaller cells ranging in size from 0 to 5 mm, most cells being from 0 to 2 mm in size.

### Example 9

Two dough formulations were prepared to compare the air cell sizes of a proofed dough versus a non-proofed dough containing 51% whole grain wheat. These dough formulations were made and analyzed using C-cell analysis.

Two dough formulations of about 5021 g were prepared according to TABLE 7 using a stand mixer. Formulation M was proofed and prepared with compressed yeast. Formulation N was not proofed and was prepared with thermostable yeast. Flour and other dry ingredients (salt sugar, dough enhancer) were mixed for 1 minute at a low speed (45 rpm) before the remaining ingredients were added. For the control, Formulation M, the compressed yeast and ice water (34° F.) were then mixed into the dough. For the test, Formulation N, the thermostable yeast and water (55° F.) were mixed with the dry ingredients. Each of the dough formulations were mixed at a low speed (45 rpm) for 1.5 minutes, followed by a high speed (80 rpm) mixing for 7 minutes. After mixing, the dough temperature for Formulation M was about 76° F. and the dough temperature was 82° F. for Formulation N. The mixed dough was then sheeted and cut to crusts of 650 g each with a central cross sectional thickness of about 5 mm and a diameter of about 16.0 inches. The crusts produced from dough Formulation M were then proofed for 48 minutes at 95° F. and 75% humidity in a proofer. For the test dough formulation N, the crusts were not proofed, but instead were covered with a plastic bag and let rest at room (temperature 65° F.) for 20 minutes.

The crusts were then blast frozen and stored at −20° F. overnight. Both the control and test crusts were then topped with 190 g of tomato sauce and 550 g of mozzarella cheese to create pizzas. These pizzas were then placed back into frozen storage at −20° F. overnight and then transferred to a 0° F. freezer until use.

TABLE 7
Whole Grain Formulations

| | Control | | Test | |
|---|---|---|---|---|
| | (Formulation M) | | (Formulation N) | |
| Description | Grams | Wt-% | Grams | Wt-% |
| Hard Wheat Flour | 1322.5 | 26.34 | 1322.5 | 26.34 |
| Whole Grain Hard Wheat Flour | 1508.2 | 30.04 | 1508.2 | 30.04 |
| Water | 1635.0 | 32.56 | 1635.0 | 32.56 |
| Compressed Yeast | 97.5 | 1.94 | | |
| Thermostable Yeast | | | 97.5 | 1.94 |
| Canola Oil | 102.4 | 2.04 | 102.4 | 2.04 |
| Sugar | 53.6 | 1.07 | 53.6 | 1.07 |
| Salt | 39.8 | 0.80 | 39.8 | 0.80 |
| Dough Enhancer | 66.2 | 1.32 | 66.2 | 1.32 |
| Oat Flour | 147.9 | 2.95 | 147.9 | 2.95 |
| Vital Wheat Gluten | 48.4 | 0.96 | 48.4 | 0.96 |
| Total | 5021.5 | 100.00 | 5021.5 | 100.00 |

After 6 weeks of frozen storage at 0° F., the pizzas were baked in a convection oven at 375° F. for 17-19 minutes. The sauce and cheese toppings were then removed, and the crust was sliced to 4.5 in by 4.5 in by 7 mm (length×width×height) pieces. The pizza crusts were then evaluated for interior texture and air cell distribution using a C-Cell Imaging System manufactured by Calibre Control International, Ltd. in Warrington, UK.

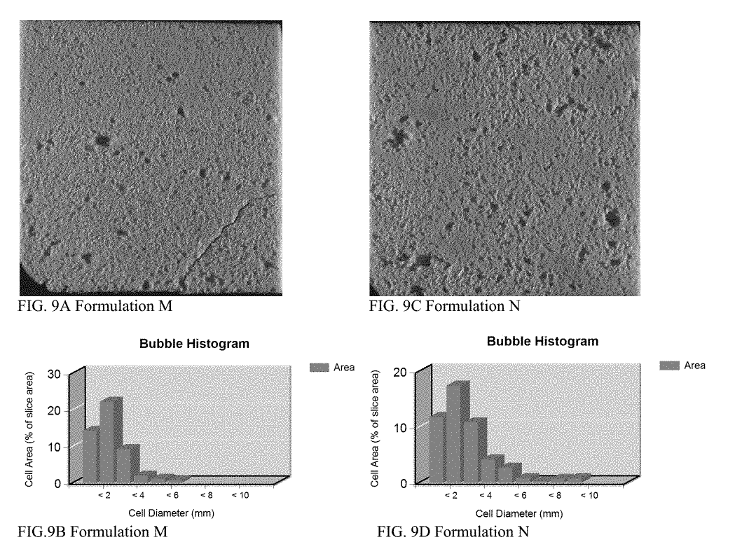

The results of the C-Cell images and histograms are given in FIGS. 9A-D. As can be seen from FIGS. 9A and 9C, the air cell distribution of Formulation N crust was improved from the control (Formulation M) in that the air cell distribution has moved toward higher diameters. This indicates larger air cell openings for the non-proofed, thermostable yeast Formulation N. The crust produced from Formulation N also had a higher number of large air cells when compared with Formulation M crusts. Larger air cells are a desirable attribute in rising crust pizza, particularly in whole grain rising crust pizza.

It was concluded that the thermostable yeast produced a non-proofed whole wheat frozen dough, which can be baked directly from the frozen state, with a crust containing more open air cells than the control made with compressed yeast and a proofing step.

### Example 10

Two dough formulations were prepared to compare the air cell sizes of a wheat dough prepared with a thermostable yeast and a control dough made with compressed yeast and chemical leavening agents. These dough formulations were analyzed using C-cell analysis.

Two dough formulations of about 2157 g were prepared according to TABLE 8 using a stand mixer. Formulation O was prepared with compressed yeast and a chemical leavening agent. Formulation P was prepared with thermostable yeast. Flour and other dry ingredients (salt sugar, dough enhancer) were mixed for 1 minute at a low speed (45 rpm) before the remaining ingredients were added. For the control, Formulation O, the compressed yeast and water (60° F.) were then mixed into the dough with the wet ingredients. For the test, Formulation P, the thermostable yeast and water (60° F.) were mixed in with the dry ingredients. Each of the dough formulations were mixed at a low speed (45 rpm) for 2 minutes, followed by a high speed (80 rpm) mixing for 5 minutes. After mixing, the dough temperatures were about 78° F. The mixed dough was then sheeted and cut to crusts of 140 g each with a central cross sectional thickness of about 5 mm and a dimension of 4 in by 6 in by 5 mm (length×width×height).

TABLE 8
Whole Grain Formulations with Chemical Leavening Agent

| | Control | | Test | |
|---|---|---|---|---|
| | (Formulation O) | | (Formulation P) | |
| Description | Grams | Wt-% | Grams | Wt-% |
| Hard Wheat Flour | 472.8 | 21.82 | 472.8 | 21.92 |
| Whole Grain Hard Wheat Flour | 526.9 | 24.31 | 526.9 | 24.42 |
| Water | 769.2 | 35.49 | 809.0 | 37.5 |
| Compressed Yeast | 70.8 | 3.27 | | |
| Thermostable Yeast | | | 51.0 | 2.36 |
| Soy Oil | 39.0 | 1.8 | 39.0 | 1.81 |
| Soy Protein Isolate | 44.6 | 2.06 | 44.6 | 2.07 |
| Fababean Flour | 200.0 | 9.23 | 180.0 | 8.34 |
| Sodium Bicarbonate | 10.0 | 0.46 | | |
| Salt | 14.0 | 0.65 | 14.0 | 0.65 |
| Sugar | 20.0 | 0.92 | 20.0 | 0.93 |
| Total | 2167.3 | 100 | 2157.3 | 100 |

The crusts of both formulations were then docked to prevent bubbling, and baked using an impingement oven without proofing. The impingement oven was set at 60% fan speed with a baking temperature of 500° F. and time of 2.5 minutes. After baking, the crusts were sliced to 4 in by 6 in by 6 mm ((length×width×height). The pizza crusts were evaluated for interior texture and air cell distribution using a C-Cell Imaging System manufactured by Calibre Control International, Ltd. in Warrington, UK.

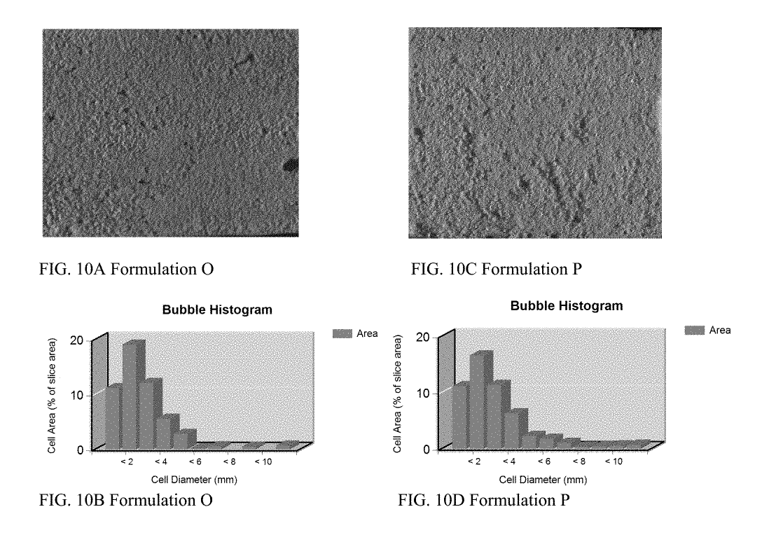

The results of the C-Cell images and histograms are given in FIGS. 10A-D. As can be seen from FIGS. 10A and 10 C, the air cell distribution of the Formulation P crust was improved from the control (Formulation O) in that the air cell distribution moved toward higher diameters, indicating larger air cell openings for thermostable yeast Formulation P. The larger air cells of Formulation P are a desirable attribute in flatbread pizzas.

It was concluded that a thermostable yeast produced a non-proofed whole grain frozen dough which can be baked directly from frozen state and produced a crust with more opened air cell structure than the control made of chemical leavening and compressed yeast.

While certain embodiments have been described, other embodiments may exist. While the specification includes a detailed description, the scope of the present disclosure is indicated by the following claims. The specific features and acts described above are disclosed as illustrative aspects and embodiments. Various other aspects, embodiments, modifications, and equivalents thereof which, after reading the description herein, may suggest themselves to one of ordinary skill in the art without departing from the spirit of the present disclosure or the scope of the claimed subject matter.

What is claimed is:

1. A method for making a bakery product, the method comprising:
mixing ingredients to produce a dough composition, the ingredients comprising water, flour, and thermostable yeast;
making up a raw bakery product from the dough composition;
leavening the raw bakery product;
freezing the leavened raw bakery product; and
baking the raw bakery product to produce a finished bakery product,
wherein the leavening the raw bakery product prior to baking consist of resting until reaching a yeast gassing plateau, and wherein the ingredients are free of chemical leaveners.

2. The method of claim 1, wherein the ingredients are free of leaveners other than thermostable yeast

3. The method of claim 1, wherein the thermostable yeast is a semi-dry yeast, a frozen yeast, a frozen dough yeast, or a combination thereof.

4. The method of claim 1, wherein the resting includes one or more rest periods having a total duration of 40 minutes or less.

5. The method of claim 1, wherein the raw bakery product has a first volume before leavening and a second volume after leavening, and the finished bakery product has a third volume, and wherein the second volume is 150% or less of the first volume, and the third volume is 200% or more of the first volume.

6. The method of claim 1, wherein the raw bakery product is baked without first thawing the bakery product before baking.

7. A method for making a bakery product, the method comprising:
mixing ingredients to produce a dough composition, the ingredients comprising water, flour, and thermostable yeast;
making up a raw bakery product from the dough composition, the made up raw bakery product having a first volume;
leavening the raw bakery product;
freezing the leavened raw bakery product; and
baking the raw bakery product to produce a finished bakery product,
wherein after leavening and immediately prior to baking the raw bakery product has a second volume that is up to 150% of the first volume, and wherein the finished bakery product has a third volume that is at least 200% of the first volume.

8. The method of claim 7, wherein the leavening does not include proofing or fermentation.

9. The method of claim 7, wherein the leavening prior to baking consists of resting until gassing reaches a plateau seen in a Risograph.

10. A method for making a bakery product, the method comprising:
mixing ingredients to produce a dough composition, the ingredients comprising water, flour, and thermostable yeast;
making up a raw bakery product from the dough composition;
leavening the raw bakery product; and
baking the raw bakery product,
wherein any leavening steps prior to baking have a total duration of 35 minutes or less, and wherein the raw bakery product has a first volume and the finished bakery product has a second volume that is at least 200% of the first volume.

11. The method of claim 10, wherein the leavening steps consist of resting for 35 minutes or less and rising during baking.

12. The method of any one of claim 1, 7, or 10, wherein the finished bakery product is a pizza.

13. The method of any one of claim 1, 7, or 10, wherein the finished bakery product is bread.

14. The method of any one of claim 1, 7, or 10, wherein the ingredients comprise one or more dough enhancers.

15. The method of claim 1 or 10, wherein the ingredients are free of chemical leaveners.

16. The method of any one of claim 1, 7, or 10, further comprising freezing the raw bakery product prior to baking.

17. The method of claim 16, where in the raw bakery product is frozen for at least 2 weeks.

18. A method for providing a bakery product, the method comprising:
mixing ingredients to produce a dough composition, the ingredients comprising water, flour, and thermostable yeast;
making up a raw bakery product from the dough composition;
leavening the raw bakery product until a yeast gassing plateau is reached;
freezing the leavened raw bakery product;
packaging the frozen raw bakery product;
distributing the packaged frozen raw bakery product with instructions to bake the frozen raw bakery product without thawing, fermenting, or proofing.

19. The method of claim 18, wherein the ingredients are free of chemical leaveners.

20. The method of claim 18 further comprising storing the frozen raw bakery product under freezing conditions.

21. The method of claim 18, wherein distributing comprises delivering the packaged frozen raw bakery product to a retail outlet or to a consumer.

22. The method of claim 18, wherein at least about 75% of yeast cells in the frozen raw bakery product are viable.

23. A non-proofed non-fermented frozen dough comprising:
a dough matrix comprising flour, water and one or more dough conditioners comprising a polysaccharide selected from propylene glycol alginate, sodium alginate, xanthan, gellan, pectin, guar gum, carrageenan, locust bean gum, gum Arabic, carboxymethyl cellulose, METHOCEL, BENECEL, or a combination thereof;
thermally stable yeast; and
a plurality of air cells,
wherein the dough has a temperature below 32° F., and wherein at least 90% of the air cells in the dough are smaller than 4 mm in diameter.

24. The non-proofed non-fermented frozen dough of claim 23, wherein the thermostable yeast is a semi-dry yeast, a frozen yeast, a frozen dough yeast or a combination thereof.

25. The non-proofed non-fermented frozen dough of claim 23, wherein the dough comprises from about 1 to about 10% of thermally stable yeast.

26. The non-proofed non-fermented frozen dough of claim 23, wherein the dough comprises from about 0.1 to about 0.6% polysaccharide.

27. The non-proofed non-fermented frozen dough of claim 23, wherein the dough contains one or more additives selected from DATEM, SSL, lecithin, monoglyceride, diglyceride, or a combination thereof.

28. The non-proofed non-fermented frozen dough of claim 23, wherein dough contains one or more oxidative agents selected from ascorbic acid, glucose oxidase, or a combination thereof.

29. The non-proofed non-fermented frozen dough of claim 23, wherein dough contains flavoring agents.

30. The non-proofed non-fermented frozen dough of claim 23, wherein the dough is at its final ornamental design and can be baked directly from freezer without having to thaw or proof.

31. The no-proofed non-fermented frozen dough of claim 23, wherein the dough comprises less than 0.1% of chemical leaveners.

32. The non-proofed non-fermented frozen dough of claim 23, wherein the dough contains sodium bicarbonate.

33. A packaged ready-to-bake frozen dough product comprising:
a frozen dough product having a dough matrix comprising:
flour, water and one or more dough conditioners comprising a polysaccharide selected from propylene glycol alginate, sodium alginate, xanthan, gellan, pectin, guar gum, carrageenan, locust bean gum, gum Arabic, carboxymethyl cellulose, METHOCEL, BENECEL, or a combination thereof;
thermally stable yeast; and
a plurality of air cells, wherein at least 90% of the air cells in the dough are smaller than 4 mm in diameter,
a packaging surrounding the dough, the packaging including instructions to bake the dough without proofing or fermenting the dough.

34. The product of claim 33, wherein the package includes instructions to bake the dough without thawing.

35. The product of claim 33, wherein at least about 75% of yeast cells in the dough are viable.

36. The product of claim 33, wherein the frozen dough product comprises a pizza.
